(19) United States
(12) Patent Application Publication
(10) Pub. No.: US 2006/0245978 A1
(43) Pub. Date: Nov. 2, 2006

(54) Fluid partitioning in multiple microchannels

(75) Inventor: Menno Willem Jose Prins, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/551,024

(22) PCT Filed: Mar. 26, 2004
(86) PCT No.: PCT/IB04/50345

§ 371 Date: Sep. 29, 2005

(30) Foreign Application Priority Data
Apr. 4, 2003 (EP) 03100892.3

(51) Int. Cl. B01L 3/00

(52) U.S. Cl. 422/100

(57) ABSTRACT

A device (3) and method to generate independent fluid samples (51) for multichannel analysis, preferably in diagnostic cartridges, are disclosed according to the invention. A fluidic device (3), preferably a microfluidic device, has a plurality of fluid channels (35). Fluids are transported in the fluid channels. A cross-over channel (32) has a fluid inlet (33) and a fluid outlet (34). In use of said device (3), a method is performed. According to the method, the sample channels are filled with sample fluid up to a threshold (39). A flush fluid (gas or inert liquid) is then flushed through the sample-filled cross-over channel, replacing the sample fluid with flush fluid. Subsequently the cross-over channels' inlet and outlet are closed and the sample fluid is pushed further into the channel arrays (30, 31). Alternatively, an appropriate pressure is applied to the fluid in order to push the fluid into said sample channels. The method steps are repeated in an appropriate way if it is desired to obtain multiple (in time and/or space) independent sample plugs in the microchannels. Thus a series of longitudinally spaced independent sample fluid segments separated from each other by flush segments is created in each microchannel.

### FIELD OF THE INVENTION

This invention pertains in general to the field of fluidic devices, and more particularly to micro-fluidic devices having several sample channels, wherein the content of the sample channels is to be analysed, and even more particularly to the handling of the fluid content in the sample channels of the micro-fluidic devices.

### BACKGROUND OF THE INVENTION

In point-of-care and homecare medical diagnostics testing cartridges are being used to detect chemical and/or biochemical components in fluids. The analysed fluids are often body fluids taken from a patient, such as samples of blood or urine. Presently only a very limited number of components, i.e. one or a few components, are being measured with a single cartridge. It is desired to detect, measure and analyse further components at the same instant and from the same fluid source. This improves the ease-of-use. However, today further cartridges have to be used in this case, which are capable of analysing the further components. This implies also that a larger quantity of sample fluid has to be available, as each cartridge needs a certain minimum amount of fluid. The term ‘multichannel analysis’ refers in this context to the capability to detect more than one component in a single cartridge.

Miniaturisation is another important trend in diagnostic cartridge technologies. The miniaturisation of the above describe cartridges gives a number of important advantages. More tests can be performed on a single fluid sample of a defined volume, as less fluid to be analysed is needed to fill the channels of the analyser on the cartridge. This increases the ease of use and reduces the chance of handling errors because less cartridges and samples have to be handled by e.g. nursing staff. As already mentioned, a lower volume of fluid sample is needed per test and the costs per test are reduced. Furthermore, multichannel analysis allows spectral detection of components in the sample fluids, and thus a larger variety of components can be analysed than in the past. Therefore cartridges become more and more suited for the field of genomics and proteomics, e.g. for multi-gene analysis, multi-expression analysis, distinguishing of protein isoforms, etc. Furthermore, redundancy can be integrated into the cartridge because more analysis devices have room on a single cartridge. This enhances the precision and the reliability of the diagnosis based on the analysis results. Finally, titration series can be applied for reagents and/or capture probes to increase the measurement range and measurement precision.

One example for a microfluidic structure is disclosed in WO91/16966. The disclosed microfluidic structure has a plurality of microcavity or channel system. A series of adjacent channels is formed on top of each other by a suitable arrangement of the layers. Other examples are planar arrangements of adjacent channels manufactured by common micromachining methods (e.g. etching, molding, printing).

When the fluid sample is distributed over a large number of several channels, e.g. 10 or 100, on a cartridge, it is a problem to generate distinct, independent sample plugs in the different channels. A separation into independent plugs is needed in order to be able to perform independent biochemical tests in each channel. Further problems associated with multichannel microfluidic devices are cross contamination and reagent carry-over. This occurs when several samples are consecutively run through the channels and the channels are not sufficiently cleaned between the samples or preceding sample fluids are not sufficiently diluted by following sample fluids in such a way, that analysis results are adversely influenced.

### SUMMARY OF THE INVENTION

One object of the invention is to minimise cross contamination and reagent carry-over between fluid plugs in the fluid channels of a microfluidic multichannel device. Another object is to provide distinct, independent sample plugs in a large number of fluid channels in a microfluidic multichannel device.

The present invention overcomes the above-identified deficiencies in the art and solves at least the above-identified problems by providing a method and device according to the appended patent claims.

According to one aspect of the invention, a fluidic device, preferably a microfluidic device, with multiple sample channels is provided. The device is adapted to analyse fluid content in the sample channels. The device comprises a plurality of sample channels arranged in close proximity to each other at least along a defined length, wherein the sample channels have a common sample fluid inlet. The sample channels are adapted to be filled through the fluid inlet with a sample fluid to be analysed, wherein filling is performed when using said device. A flush fluid control means, preferably a cross-over channel, is positioned at the inlet of said plurality of sample channels. The flush fluid control means has at least one flush fluid inlet means and at least one flush fluid outlet means, wherein both are in fluid communication with said sample channels' inlet. The flush fluid control means is adapted to control the fluid composition, i.e. flush or sample fluid, at the inlet of the multiple sample channels.

More particularly, a flush fluid, i.e. a gas or a liquid, is passed from the inlet channel to the outlet channel via the cross-over channel, whereby sample content in the sample channels is locally removed when the flush fluid is pushed into the sample channels. Thus independent sample plugs in the sample channels are formed.

Preferably a threshold is provided in the sample channels to control partial filling of the sample channels.

Preferably, the microfluidic device for multichannel analysis of fluid samples is housed inside a cartridge. The cartridge is sometimes also called a microfluidic chip, or a lab-on-a-chip, or a micro-total-analysis-system. In biological applications is can also be called a biochip or a biosensor.

According to another aspect of the invention, a method of generating independent fluid samples in multiple fluid channels of a fluidic, preferably a microfluidic, device for multichannel analysis of said fluid samples is provided. A flush fluid control means is flushed with flush fluid such that independent sample plugs are formed in a multichannel array of the device. According to the method, the sample plugs are separated by flush fluid and thus independent sample plugs are generated. In more detail, a flush fluid control means, preferably a cross-over channel, has flush fluid inlet means and flush fluid outlet means and the method comprises preferably the following steps. The flush fluid inlet means and flush fluid outlet means are closed by means of a valve means. The valve means can be present outside the cartridge or can be integrated inside the cartridge. Then sample liquid is introduced into the device through a sample fluid inlet into the multiple fluid channels. Subsequently, the sample liquid is transported across the flush fluid control means and further into the channels, preferably up to a threshold in the channels. Then the flush fluid inlet means and flush fluid outlet means are re-opened by means of the valve means and the flush fluid control means is flushed with a flush fluid. Subsequently, the sample liquid in said channels and said flush liquid in said flush fluid control means are transported, preferably pushed, across said flush fluid control means and further into the channels.

According to a further aspect of the invention, a computer-readable medium having embodied thereon a computer program for processing by a computer is provided. The computer program comprises code segments for achieving independent sample plugs in multiple fluid channels of a fluidic, preferably a microfluidic, multichannel device. The computer program comprises a code segment instructing a computer to accomplish flushing of a flush fluid control means with flush fluid such that independent sample fluid plugs are formed in a multichannel array of the device, so that the sample plugs are separated by said flush fluid.

### BRIEF DESCRIPTION OF THE DRAWINGS

Preferred embodiments of the present invention will be described in the following detailed disclosure, reference being made to the accompanying drawings, in which

FIG. 1 is a schematic diagram illustrating a multichannel analysis device;

FIG. 2 is a planar sectional view of a microchannel array in a multichannelx analysis device;

FIG. 3 is a schematic illustration of an embodiment of the invention illustrating a multichannel array with a cross-over channel, filled with a flush fluid such as air or an inert liquid;

FIG. 4 is a schematic illustration of the multichannel array according to FIG. 3 with closed cross-over valves and microchannels partly filled with sample fluid;

FIG. 5 is a schematic illustration of the multichannel array according to FIG. 3 with opened cross-over valves wherein the cross-over channel is flushed with air or an inert liquid;

FIG. 6 is a schematic illustration of the multichannel array according to FIG. 3 with closed cross-over valves and independent sample plugs in the multichannel array;

FIG. 7 is a flow-chart of an embodiment of the method of the present invention;

FIG. 8 is a schematic diagram of an embodiment of the computer readable medium of the present invention, and

FIGS. 9 and 10 are schematic illustrations of alternative channel architectures.

### DESCRIPTION OF EMBODIMENTS

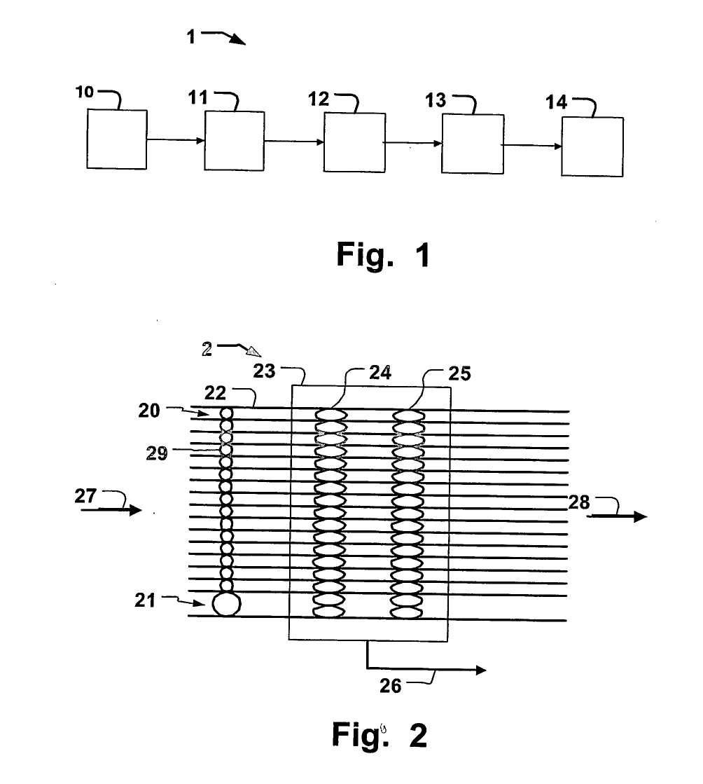

Now turning to the figures, FIG. 1 shows an exemplary device architecture for multichannel analysis. A sample fluid is pre-treated and subsequently distributed over a plurality of channels, e.g. 10 or 100 channels. In every channel specific reagents are added, such as affinity labels, salts, sugars, detergents, etc. Subsequently measurements are made. The measurements are e.g. based on capture and detection. For example, immobilised capture molecules (e.g. proteins, antibodies, peptides, oligonucleotides, cDNA, aptamers, sugars) are deposited inside the cartridge, either on the walls of the cartridge or via micro- or nanoparticles. The capture molecules can be deposited in the cartridge by various methods, e.g. pin-spotting, inkjet deposition, or photochemical reactions. When exposed to a sample fluid, the capture molecules selectively bind target molecules from the fluid sample.

Detection can be done in many ways know in the art, e.g. optically, electrically, magnetically, mechanically. The detection generally involves the chemical or biochemical attachment of detection labels. The labelling can occur before the capturing or after the capturing. The labels may be active in different ways, such as optically active (e.g. fluorescent, chemiluminescent, scattering particles), electrically active (e.g. redox labels), magnetically active (e.g. magnetic particles), mechanically active (e.g. mass labels), or (bio)chemically active (e.g. enzymes).

Fluid analysis may also be performed with label-free methods such as electromagnetic spectrometry, mass spectrometry, nuclear magnetic resonance, conductivity measurements, etc.

Washing or stringency steps (e.g. with a fluid solution, magnetic forces, temperature changes, electric fields) and cross-linking reactions (e.g. photo-cross linking with aptamers) may reduce background signals and improve the sensitivity and specificity of the detection.

During these processes, the fluid may be agitated, creating fluid movement that enhances the interaction rates.

In more detail, the schematic diagram of FIG. 1, shows a multichannel analysis device 1 having sample introduction means 10 for inserting a fluid sample into the device 1. From introduction means 10, the sample is forwarded within the device, e.g. by means of pumps, pressure differences, valve arrangements or if the fluid contains electrically charged particles, by means of an electric field. By means of a fluid pre-treatment means 11, the content of the entire sample may be pre-treated, e.g. by filtering, pre-concentration, anti-clotting treatment. Further, the sample is distributed to channels of a microchannel array. An example 2 of such a microchannel array is shown in FIG. 2. The channel array 22 comprises a plurality of microchannels 20, wherein every channel contains its own reagents 29, which can be added at means 12. Optionally each channel comprises a channel-specific pre-treatment. Thus, every channel 20 can have its own optimised chemical environment. The channels can have unequal widths, which is illustrated with e.g. a double width for the lowest channel 21 in the FIG. 2. In that way, a 2D-capture-array can be accommodated in the device 1. Valves and pumps (not shown) can be applied in the channels 20, 21 for controlling the fluid flow in the channels.

Measurement means 13 for sample fluid analysis, such as an array of probes 24, 25 are arranged in the microchannels. The probes deliver signals, which are fed to a detector for further analysis, as indicated by arrow 26. Arrows 27 and 28 illustrate the fluid flow in and out of the microchannels respectively.

Finally, the sample fluid is discarded by sample waste means 14.

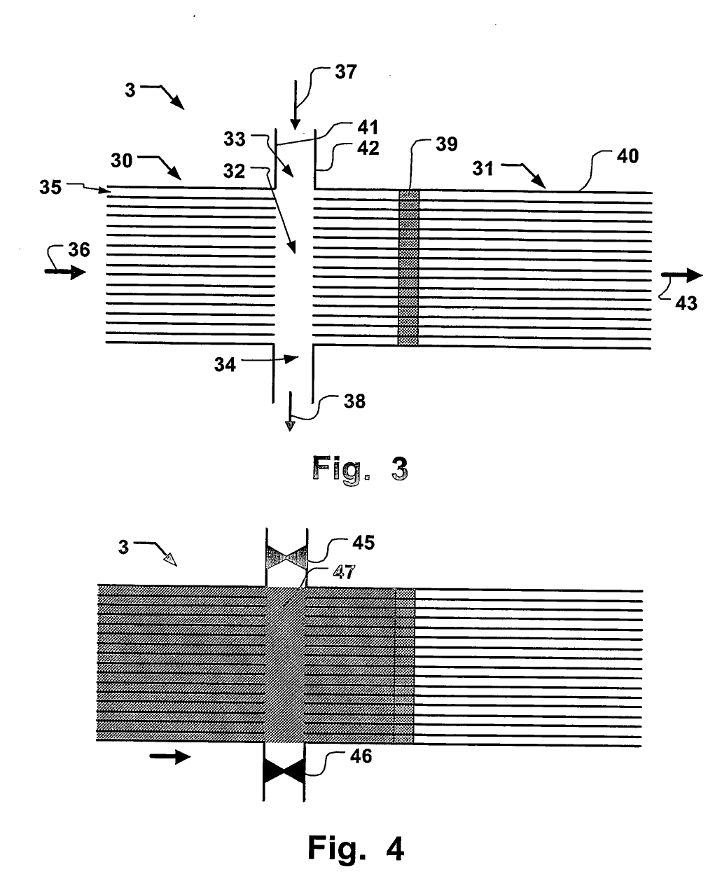

In a preferred embodiment of the invention according to FIGS. 3 to 6, a multichannel device 3 is shown. For the sake of a clearer illustration, reference numerals are not repeated for the same elements shown throughout FIG. 3 to 6. The device 3 comprises two side channels 33, 34, namely a fluid inlet 33 and a fluid outlet 34, wherein the fluid is a gas or an inert liquid. Furthermore a cross-over channel 32 connects the fluid inlet 33 and the fluid outlet 34, both having side-walls 41, 42. Fluid flow into fluid inlet 33 is indicated by arrow 37 and fluid flow out of fluid outlet 34 is indicated by arrow 38. Fluid inlet 33 and fluid outlet 34 comprise valves 45, 46 (not shown in FIG. 3) for fluid control.

The cross-over channel 32 divides two arrays 30, 31 of microchannels 35 having side walls 40 as well as top and bottom walls (not shown) in order to provide a fluid flow channel for sample fluid and other fluids. A sample liquid is introduced, as shown by arrow 36, into the microchannel-array 30, where the sample fluid may be pre-treated as described by fluid pre-treatment means 11. Alternatively, the fluid can be pre-treated outside the cartridge, e.g. by filtering, as well as inside the cartridge. However, the array 30 being an input to cross-over channel 32 is a non-limiting example of an input structure to the inventive cross-over channel 32, as well as a channel structure. Examples for other valid architectures within the inventive concept are shown in FIGS. 9 and 10. In the architecture 9 shown in FIG. 9, an input channel 90 is split to two microchannels 91, 92. A cross-over channel is located a certain distance from the junction where input channel 90 is split to the two channels. Cross-over channel 93 covers the whole array of microchannels 91, 92 as illustrated in FIG. 9. FIG. 10 shows a single input channel 100 for two microchannels 101, 102. A cross-over channel 103 is arranged in such a way that a sample fluid travelling in input channel 100 towards the channels 101, 102 is split to two simultaneous fluid flows at the junction, where the input channel 100 merges with the cross-over channel 103. The sample fluid traverses the cross-over channel 103 towards the respective channel of the two channels 101, 102.

The arrows shown in FIG. 9 and FIG. 10 respectively, indicate the direction of flow of the sample fluid in the input channels 90 and 100 respectively. The flush/separation fluid flows through respective cross-over channel as described in connection with the embodiment shown in FIGS. 3 to 6. For illustrative purposes, the number of channels has been limited to one input channel and two output channels in FIGS. 9 and 10; wherein this illustrative limitation shall be regarded as non-limiting within the inventive concept of the present application.

The sample fluid passes the cross-channel into the second microchannel-array 31. A threshold 39 is arranged in array 31. Threshold 39 is e.g. a physical constriction in the channel, a small hydrophobic region, or a valve. The purpose of threshold 39 is to detect the presence of a certain fluid or to restrict the flow of fluid in microchannels 35 in a controlled way. There are several ways to make a fluid threshold in the microchannels. One way is by exploiting capillary forces, e.g. locally apply a fluidophobic material (e.g. hydrophobic). Another way is to have a size-constriction in the channels.

It is advantageous to be able to tune the fluid threshold, for example (to remove the threshold when the fluid is meant to pass. This can for example assure a synchronised fluid movement in all channels. One way to make a tuneable threshold is with electric fields, e.g. by electrowetting (an electric field causes the hydrophobic material to become less hydrophobic), local temperature change (heating changes capillary forces), application of light (some materials change capillary properties under light excitation), or external pressure (channel diameter tuned by external pressure, e.g. by using a microchannel with a flexible wall).

Preferably the fluid threshold in all channels is tuned by one control line, such as one electrode, one light guide, etc.

In certain cases it can be advantageous to have multiple thresholds in every channel, such that the fluid can assume several well-defined positions in the channels.

The sample fluids are exhaust from microchannel array 31, as indicated at arrow 43.

In use of device 3, the side channels are first closed and sample fluid enters into the multichannel structure, as indicated through reference numeral 47. As shown in FIG. 4, the channels 35 are filled up to threshold 39. To prevent fluid flow through side channels 33, 34, valves 45, 46 are closed.

A variety of methods and means may be used for actuating fluids in and out of or within the microfluidic device. Actuating may be done by means outside the cartridge, e.g. an external overpressure, an external underpressure (vacuum), a membrane that is mechanically actuated from outside. Alternatively means inside the cartridge are used, e.g. electrokinetic effects, electrophoresis, electrowetting, membranes, soft-lithographic microfluidics, etc.

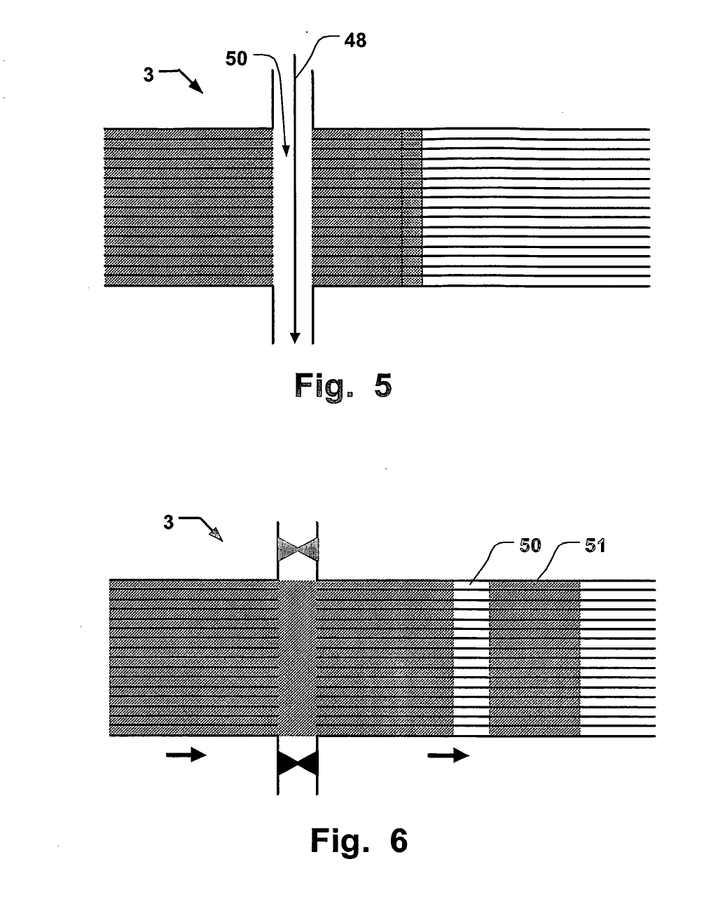

Then the side channels 33, 34 are opened, as indicated in FIG. 5 and the sample fluid 47 present in cross-over channel 32 is flushed with a flush medium 50 out of the cross-over channel 32, as illustrated by arrow in FIG. 5. Cross-over channel 32 is thus filled with the flush medium 50. The flush medium 50 is a fluid different than the sample fluid, e.g. the flush fluid is air or an inert liquid. The flush fluid does not only have the purpose of flushing sample fluid present in cross-over channel 32, but has also other advantageous characteristics, such as to clean the channels through which it flows. Furthermore, in case the fluid is a gas such as air, the channels through which it flows are also dried. In the present embodiment, the cross-over channel 32 and subsequently the microchannels, are treated by the flush fluid as illustrated in FIGS. 5 and 6.

Thereafter the side channels 33, 34 are closed, as shown in FIG. 6, and the fluid present in arrays 30, 31 and cross-over channel 32 is pushed further into the multichannel structure. The result is that the fluid sample is partitioned. Every microchannel of the multichannel structure now contains an independent plug 51 with sample fluid, which is separated by a plug 50 with flush medium. Therefore the flush medium fulfills now the purpose of a separation medium, and the flush fluid is also called separation fluid.

Connection of the input and/or output of the cross-over channel is accomplished e.g. by microplumbing means such as hose connections. Alternatively the cross-over channels' input and/or output connections are integrally manufactured in the same manufacturing process as the microchannels.

By repeating the sequence as illustrated in FIGS. 4 to 6, a consecutive series of independent sample plugs is achieved by the invention.

As will be appreciated, the design of the cross-over channels' input and output connections is not limited to the embodiment shown in FIG. 3 to FIG. 6. Moreover, the input of the channels can alternatively be arranged in the top and/or bottom wall of the cross-over channel, such that the gas or inert liquid separating the sample plugs is introduced into the cross-over channel from the top or bottom of the channel. This stacked arrangement of fluid transport channels can be combined with the ports shown in FIGS. 3 to 6, wherein the function shown in FIGS. 3 to 6 can be different in alternative embodiments, i.e. that e.g. both ports 33, 34 can alternatively be used as output channels. In this case the gas or inert liquid is introduced through the top/or bottom inputs, further it is flushed through the cross-over channel and then output through ports 33, 34.

It will also be appreciated, that the orientation of cross-over channel 32, as shown in FIGS. 3 to 6, i.e. perpendicular to the flow in the sample channels, can alternatively be inclined in relation to the flow-direction in the micro-channels. In this way, a time-delay between the independent sample plugs can be accomplished, which in certain applications might be desirable.

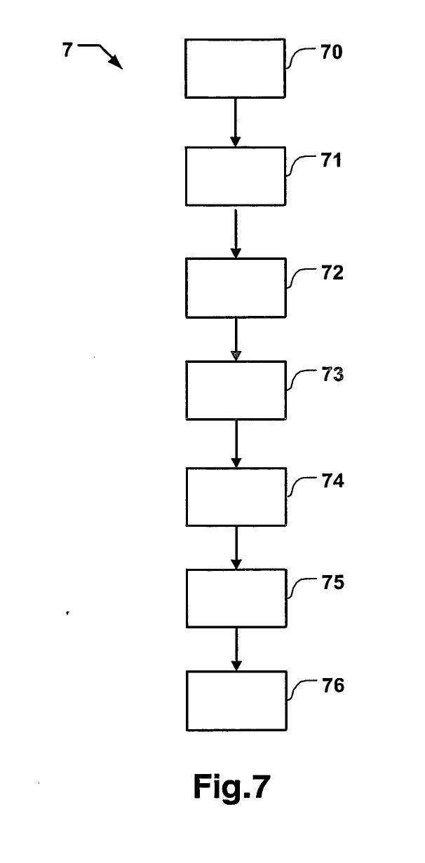

An embodiment of another aspect of the invention is illustrated in FIG. 7. A method 7 for providing independent sample plugs in an array of multiple microchannels comprises the following steps, wherein multiple microchannels are comprised in a multichannel analysis device 3. In step 70 the cross-over channel 32 of device 3 connecting fluid inlet 33 and fluid outlet 34 is flushed with a flush fluid. The flush fluid is a gas or an inert liquid. The cross-over channel 32 divides two arrays 30, 31 of microchannels 35 as described above.

In step 71 valves 45, 46 are closed in a fluid tight-manner, so that no fluid can enter or leave the cross-over channel through the side channels 33, 34. Subsequently a sample liquid is introduced into device 3 in step 72, wherein the sample fluid is transported via array 30, passing the cross-channel, into the second microchannel-array 31. Step 72 comprises that said sample fluid is introduced no further into microchannels 35 of the array than to a threshold 39 which is arranged in array 31 at a defined distance from cross-over channel 32. In the next step 73, valves in the side channels 33, 34 are opened. In the following step 74 the sample fluid present in the cross-over channel 32 is flushed with a flush medium out of the cross-over channel. The flush medium is introduced into the cross-over channel 32 through inlet port 33, whereas outlet port 34 serves to remove sample fluid from the cross-over channel 32. Thus cross-over channel 32 is filled with flush medium in step 73. Valves, capillary forces or other suitable means prevent that flush fluid enters microchannels 35 in both arrays 30, 31. Subsequently, the valves 45, 46 in side channels 33, 34 are re-closed in step 75, re-sealing side channels in a fluid-tight manner. Alternatively, instead of re-closing the side-channels, the flush fluid is in step 75 put under pressure to push the sample fluid into the microchannel structure, as described below.

In the following step 76 of the method 3, the fluid present in arrays 30, 31 and cross-over channel 32 is pushed further into the multichannel structure. The result is that the fluid sample is partitioned. Every microchannel of the multichannel structure now contains an independent plug 51 with sample fluid, which is separated by a plug 50 with flush medium. In order to create a consecutive series of independent sample plugs in array 31, steps 72 to 76 are repeated, wherein step 76 stops transporting the fluids when sample fluid reaches the threshold 39. Thus a series of longitudinally spaced independent sample fluid segments separated by each other by flush fluid segments is created in each microchannel.

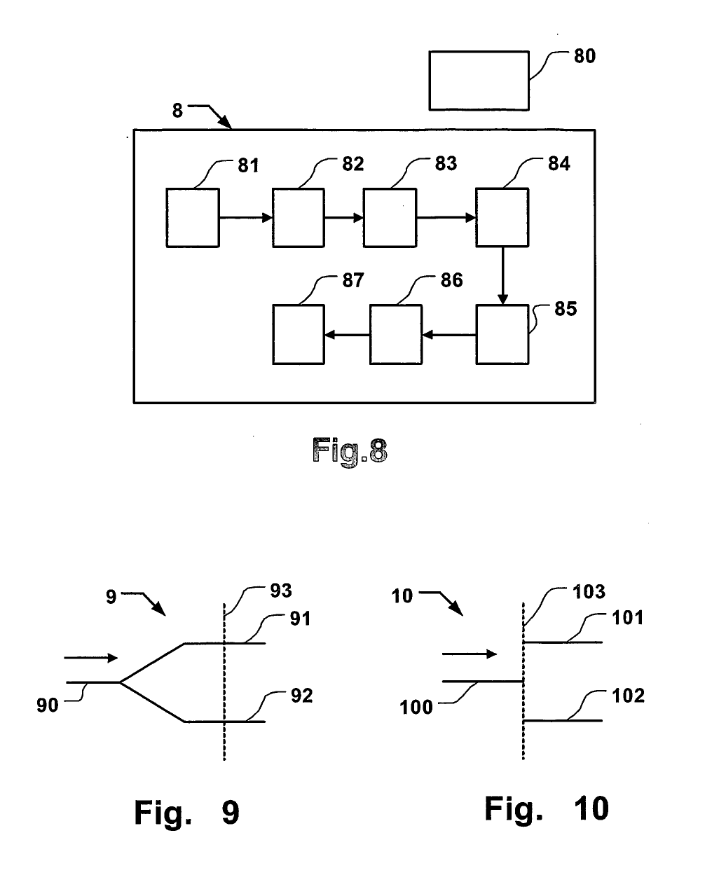

In another embodiment of the invention according to FIG. 8, a computer-readable medium 8 carries a computer program for processing by a computer 80. The computer program has several code segments to be executed by the computer 80, wherein the computer 80 controls a multichannel analysis device 3. A first code segment 81 instructs the computer to flush a cross-over channel 32 of device 3 connecting fluid inlet 33 and fluid outlet 34 with a flush fluid. By means of code segment 82 valves 45, 46 are closed in a fluid tight-manner. Subsequently a sample liquid is introduced into device 3 by means of code segment 83 instructing computer 80, wherein the sample fluid is transported via array 30, passing the cross-channel, into the second microchannel-array 31. Code segment 83 instructs the computer further such that said sample fluid is introduced no further into microchannels 35 of the array than to a threshold 39 is arranged in array 31 a defined distance from cross-over channel 32. Computer 80 is instructed by code segment 84 to open valves in the side channels 33, 34. Subsequently, code segment 85 instructs the computer to flush the cross-over channel 32 with a flush medium out of the cross-over channel, wherein the flush medium is introduced into the cross-over channel 32 through inlet port 33, whereas outlet port 34 serves to remove sample fluid from the cross-over channel 32. Thus cross-over channel 32 is filled with flush medium by means of code segment 84. Then the valves 45, 46 in side-channels 33,34 are re-closed by means of code segment 86, re-sealing side channels in a fluid-tight manner. Alternatively, instead of re-closing the side-channels, the flush medium by means of code segment 84 put under pressure to push the sample fluid into the microchannel structure, as described below. In the following, code segment 87 instructs computer 80 to push the fluid present in arrays 30, 31 and cross-over channel 32 further into the multichannel structure. The result is that the fluid sample is partitioned. Every microchannel of the multichannel structure now contains an independent plug 51 with sample fluid, which is separated by a plug 50 with flush medium. In order to create a consecutive series of independent sample plugs in array 31, code segments 83 to 87 are repeated, wherein step 87 stops transporting the fluids when sample fluid reaches the threshold 39.

Applications and use of the above described device and method of the present invention are various and include exemplary fields such as clinical analysis, chemical analysis, biochemical analysis, etc. The samples in the microchannels can be analysed for concentrations of e.g. sodium, potassium, chloride, ionised calcium, pH, pCO₂, pO₂, urea, glucose, hematocrit, HCO₃, hemoglobin, proteins, nucleic acids, hormones, to name a few. Depending on the chemical characteristics of the sample fluid to be analysed, the microchannels can be manufactured in e.g. silicon, ceramic, or a plastic material by common micromachining manufacturing methods. Generally, any etchable or moldable material is suitable. Furthermore the array of microchannels can be arranged in a variety of configurations, such as stacked on top of each other, side by side with a bottom and a top layer and side walls enclosing the channels, etc. Microfabrication techniques allow high quality manufacturing in high volumes resulting in low prices of the manufactured products, in this case of the multiple microchannels.

The microchannel array is preferably arranged inside a cartridge housing (not shown) for easy handling. The cartridges are also called diagnostic cartridges. Such a cartridge is generally a disposable, single use article and is thrown away after use. However, during use a plurality of samples can be analysed consecutively.

Furthermore, the microfluidic device has been described in connection with fluid analysis. However, the microfluidic device may also be used also for fluid synthesis, or the parallel synthesis of chemical compounds, i.e. as a lab-on-a-chip, or process-on-a-chip. Synthesis is of interest in fields such as biomedical, pharmaceutical or chemical materials research or materials applications.

The present invention has been described above with reference to specific embodiments. However, other embodiments than the preferred above are equally possible within the scope of the appended claims, e.g. different structures of the microfluidic devices' channels than those described above, performing the above method by hardware or software, etc.

Furthermore, the term “comprising” does not exclude other elements or steps, the terms “a” and “an” do not exclude a plurality and a single processor or other units may fulfil the functions of several of the units or circuits recited in the claims.

1. A fluidic device (3, 9, 10), comprising
a plurality of sample channels (35, 91, 92, 101, 102),
said sample channels (35, 90, 100) having a sample fluid inlet (36),
said sample channels (35, 91, 92, 101, 102) being adapted to be filled through said inlet (36, 90, 100) with a sample fluid to be analysed or treated in use of said device (3),
a flush fluid control means (32, 93, 103) positioned at said plurality of sample channels (35) downstream the location where the sample fluid is analysed or treated in said device (3, 9, 10),
said flush fluid control means (32, 93, 103) having flush fluid inlet means (33) and flush fluid outlet means (34) in communication with said sample channels (35), and
said flush fluid control means (32, 93, 103) being adapted to control the fluid composition (47, 50) in said plurality of sample channels.

2. Fluidic device according to claim 1, wherein said fluid device (3, 9, 10) is a microfluidic device, at least partly manufactured by micromachining methods.

3. Fluidic device according to claim 1, wherein said flush fluid control means (32) controls said flush fluid content at said channel inlet (36) by replacing a fixed amount of said sample fluid (47) in said sample channels (35, 91, 92, 101, 102) with flush fluid (50) upstream said fluid control means (32, 93, 103).

4. Fluidic device according to claim 2, wherein said control means is a cross-over channel (32).

5. Fluidic device according to claim 4, wherein the cross-over channel (32) divides two arrays (30, 31) of microchannels (35).

6. Fluidic device according to claim 1, wherein said fluid inlet and fluid outlet means of said fluid control means (32) are inlet (33) an outlet (34) channels.

7. Fluidic device according to claim 6, wherein said inlet and outlet channels comprise valve means (46, 47) for controlling flush fluid communication through said inlet (33) and fluid communication through said outlet channel (34).

8. Fluidic device according to claim 1, wherein said device comprises pressure regulating means (46, 47) for controlling flush fluid communication through said inlet (33), fluid communication through said outlet channel (34) and fluid flow through said sample channels (35, 91, 92, 101, 102).

9. Fluidic device according to claim 1, comprising at least one threshold (39) being arranged in said sample channels (35) upstream said flush fluid control means (32, 93, 103) in the fluid flow direction of said sample fluid.

10. Fluidic device according to claim 9, wherein said threshold (39) is tuneable.

11. Fluidic device according to claim 9, wherein said threshold (39) is in each of said channels is controlled by a physical constriction, a fluidophobic or hydrophobic effect, an electric field, a temperature or light excitation.

12. Fluidic device according to claim 9, wherein said threshold (39) is controlled by a common control for all channels.

13. Fluidic device according to claim 1, wherein independent sample plugs (51) are formed in said sample channels by said control means (32).

14. Fluidic device according to claim 1, wherein said flush fluid is a gas or an inert liquid.

15. Fluidic device according to claim 1, wherein said fluidic device is arranged inside a compact housing, said housing being a diagnostic cartridge.

16. Fluidic device according to claim 1, wherein said fluidic device is a diagnostic cartridge, a microfluidic chip, a lab-on-a-chip, a micro-total-analysis system, a biochip or a biosensor.

17. A method of generating independent fluid samples (51) in a fluidic device (3, 9, 10) for multichannel analysis according to claim 1, said method comprising the steps of flushing of a flush fluid control means (32, 93, 103) with flush fluid such that independent sample plugs are formed in a multiple channels (31) of said device (3), said sample plugs being separated by said flush fluid.

18. A method according to claim 17, said flush fluid control means (32) having flush fluid inlet means (33) and flush fluid outlet means (34), said method further comprising the steps of
introducing sample liquid into said device (3) through a sample fluid inlet into a plurality of channels,
transporting said sample liquid across said flush fluid control means (32) further into said channels until a threshold (39),
opening of said flush fluid inlet means (33) and flush fluid outlet means (34) by means of said valve means (46, 47),
flushing of said flush fluid control means (32) with a flush fluid,
transporting said sample liquid in said channels and said flush liquid in said flush fluid control means (32) across said flush fluid control means (32) further into said channels.

19. A method according to claim 18, wherein a plurality of consecutive independent sample fluid plugs are generated by repeating said steps of
opening of said flush fluid inlet means (33) and flush fluid outlet means (34) by means of said valve means (46, 47),
flushing of said flush fluid control means (32) with a flush fluid,
transporting said sample liquid in said channels and said flush liquid in said flush fluid control means (32) across said flush fluid control means (32) further into said channels.

20. A method according to claim 18, wherein after the step of flushing said flush fluid control means (32) with a flush fluid,
said flush-fluid inlet means (33) and flush-fluid outlet means (34) are re-closed by means of valve means (46, 47), or
said flush fluid is put under pressure for transporting said sample fluid into said channels.

21. A method according to claim 17, wherein said multichannel analysis is performed in a diagnostic cartridge, a microfluidic chip, a lab-on-a-chip, a micro-total-analysis system, a biochip or a biosensor.

22. A method according to claim 17, wherein said multichannel analysis is performed by a microfluidic device.

23. A computer-readable medium (8) having embodied thereon a computer program for processing by a computer (80) for generating independent fluid samples (51) in a fluidic device (3) for multichannel analysis according to claim 1, the computer program comprising a code segment (81) for flushing of a flush fluid control means (32) with flush fluid such that independent sample fluid plugs (51) are formed in a multichannel array (31) of said device (3), said sample plugs being separated by said flush fluid.

24. Use of the method according to claim 17 for fluid analysis, fluid synthesis, or the parallel synthesis of chemical compounds.
